(19) United States
(12) Patent Application Publication
(10) Pub. No.: US 2014/0285118 A1
(43) Pub. Date: Sep. 25, 2014

(54) LIGHT EMITTING APPARATUS CAPABLE OF SUPPRESSING NOISE

(71) Applicant: Nisho Image Tech Inc., New Taipei City (TW)

(72) Inventor: Harunobu Yoshida, Ushiku City (JP)

(73) Assignee: Nisho Image Tech Inc., New Taipei City (TW)

(21) Appl. No.: 14/215,169

(22) Filed: Mar. 17, 2014

(30) Foreign Application Priority Data
Mar. 19, 2013 (TW) 102205044

(51) Int. Cl. H05B 33/08

(52) U.S. Cl. CPC H05B 33/0803
USPC 315/323

(57) ABSTRACT

A light emitting apparatus capable of suppressing noise includes: a plurality of light emitting chips and a drive circuit. Each light emitting chip includes a plurality of light emitting units and a scanning circuit. The scanning circuit is electrically connected to the light emitting units, so as to receive a frequency signal combination, and sequentially scans the light emitting units so as to selectively enable the scanned light emitting units to emit light. The drive circuit is electrically connected to the light emitting chips, to provide a frequency signal combination for each light emitting chip. The frequency signal combinations are grouped into a plurality of groups. At least two of the groups have a delay therebetween, so that the light emitting units corresponding to a same serial number emit light successively according to the delay.

### CROSS-REFERENCES TO RELATED APPLICATIONS

This non-provisional application claims priority under 35 U.S.C. §119(a) on Patent Application No. 102205044 filed in Taiwan, R.O.C. on 2013 3, 19, the entire contents of which are hereby incorporated by reference.

### BACKGROUND

1. Technical Field

The disclosure relates to a light emitting apparatus, and in particular, to a light emitting apparatus capable of suppressing noise.

2. Related Art

Electro-photography is used as a core technology for printing in photocopiers, printer and fax machines, and multi-function printers, that is, photographic images are generated by light of a specific wavelength that changes the distribution of electrostatic charges.

Referring to FIG. 1, FIG. 1 is a schematic view of a light emitting diode (LED) printer 100 for color printing. The LED printer 100 has photo-conductive drums (110K, 110M, 110C, and 110Y, which are referred to as photo-conductive drums 110 in general) and toner cartridges (130K, 130M, 130C, and 130Y, which are referred to as toner cartridges 130 in general) corresponding to black, magenta, cyan, and yellow. After passing through an electricity distribution mechanism, a uniform electric charge layer is generated on the surface of the photo-conductive drum 110. Before printing, a file to be printed needs to be subjected to an exposure program before the scanning program, so that pattern pixels in the file to be printed are converted to visible light brightness data. A printing head 120 includes a plurality of LEDs arranged in one dimension, and when the light emitted by the LEDs are incident on the photo-conductive drum 110, an unexposed area maintains original potential, while charges in an exposed area become different due to the exposure. With different potential changes in the exposed area, toner with positive/negative electric charges provided by the toner cartridge 130 can be absorbed, thereby achieving the purpose of printing.

The number of LEDs determines the printing resolution, for example, to achieve printing resolution of 600 dots per inch (DPI), 600 LEDs need to be arranged per inch. However, transient current consumption increases if so many LEDs are driven at the same time, which changes the power supply of the printing head 120, and easily causes a malfunction of the printing head 120.

### SUMMARY

Accordingly, the disclosure is directed to a light emitting apparatus capable of suppressing noise, so as to solve the problem of malfunction of a printing head caused by large transient current consumption in the prior art.

An embodiment of the disclosure provides a light emitting apparatus capable of suppressing noise, which includes a plurality of light emitting chips and a drive circuit. Each light emitting chip includes a plurality of light emitting units and a scanning circuit.

The scanning circuit is electrically connected to the light emitting units, so as to receive a frequency signal combination, and sequentially scans the light emitting units to selectively enable the scanned light emitting units to emit light. The drive circuit is electrically connected to the light emitting chips, to provide a frequency signal combination for each light emitting chip. The frequency signal combinations are grouped into a plurality of groups. At least two of the groups have a delay therebetween, so that the light emitting units corresponding to the same serial number emit light successively according to the delay.

The light emitting apparatus capable of suppressing noise according to the disclosure can prevent too many light emitting chips from driving light emitting units to emit light at the same time, thereby avoiding disturbing a working voltage of a printing head and avoiding a malfunction of the printing head. Moreover, by arranging a delay between different light emitting chips, the problem of inconsistent luminance of the light emitting units can be solved.

### BRIEF DESCRIPTION OF THE DRAWINGS

FIG. 1 is a prior art of schematic view of an LED printer for color printing;

FIG. 2 and FIG. 3 are general schematic views of a light emitting apparatus capable of suppressing noise according to an embodiment of the disclosure;

FIG. 4 is a general schematic view of a light emitting chip according to an embodiment of the disclosure;

FIG. 5 is a general schematic view of a scanning circuit according to an embodiment of the disclosure;

FIG. 6 is a general schematic view of a buffer according to an embodiment of the disclosure;

FIG. 7 is an oscillogram of a frequency signal combination according to an embodiment of the disclosure;

FIG. 8 is an oscillogram of a delay between scanning signals of different light emitting chips according to an embodiment of the disclosure;

FIG. 9 is an oscillogram of a delay between control signals of different light emitting chips according to an embodiment of the disclosure;

FIG. 10 is an oscillogram of a scanning signal without a delay according to an embodiment of the disclosure;

FIG. 11 is an oscillogram of a scanning signal with a delay according to an embodiment of the disclosure;

FIG. 12 is an oscillogram of a delay between scanning signals of different light emitting chips according to another embodiment of the disclosure;

FIG. 13 is an oscillogram of a delay between control signals of different light emitting chips according to another embodiment of the disclosure;

FIG. 14 is a general schematic view of a drive circuit according to an embodiment of the disclosure;

FIG. 15 is a general schematic view of a scanning circuit according to another embodiment of the disclosure; and

FIG. 16 is a general schematic view of a scanning circuit according to still another embodiment of the disclosure.

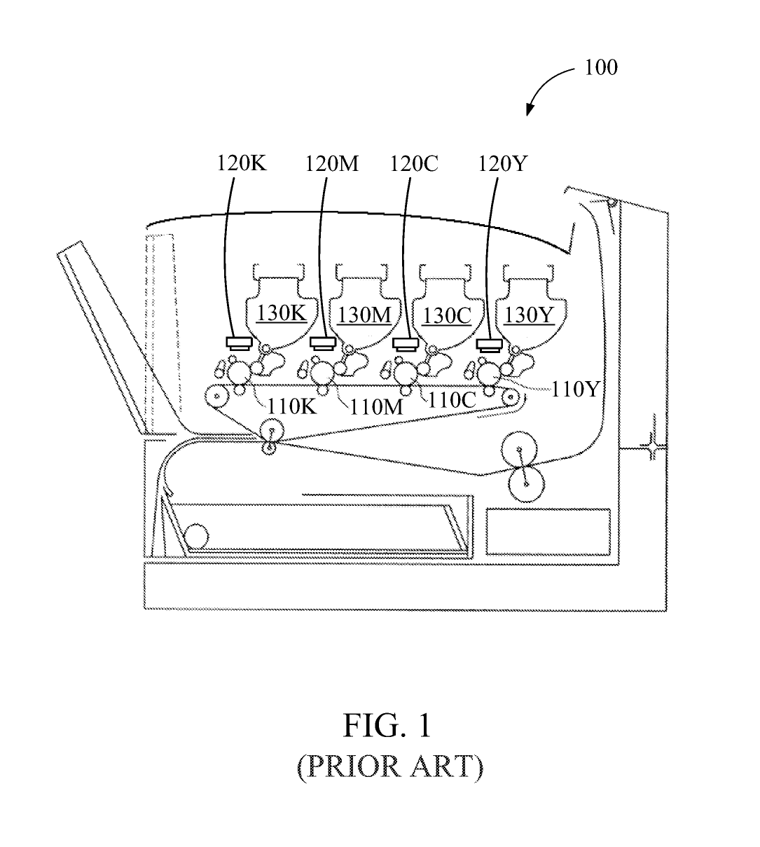

### DETAILED DESCRIPTION

The terms such as “first” and “second” in the following are used for distinguishing specified components, but are not used for sorting or for defining the difference of the specified component, and are not used for limiting the scope of the disclosure either.

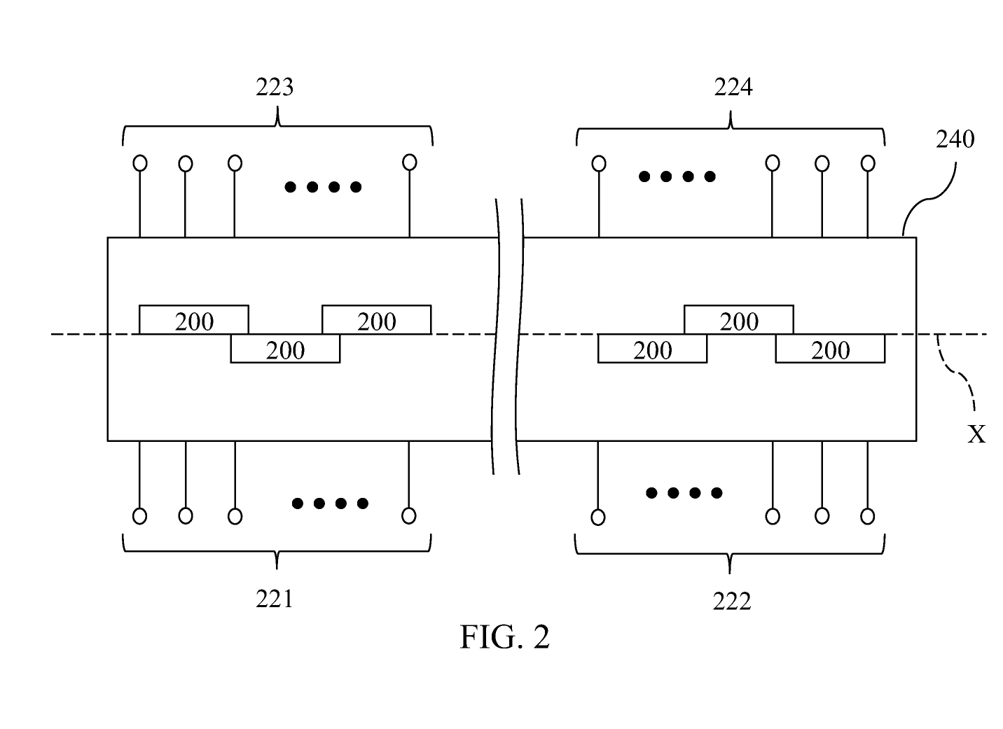

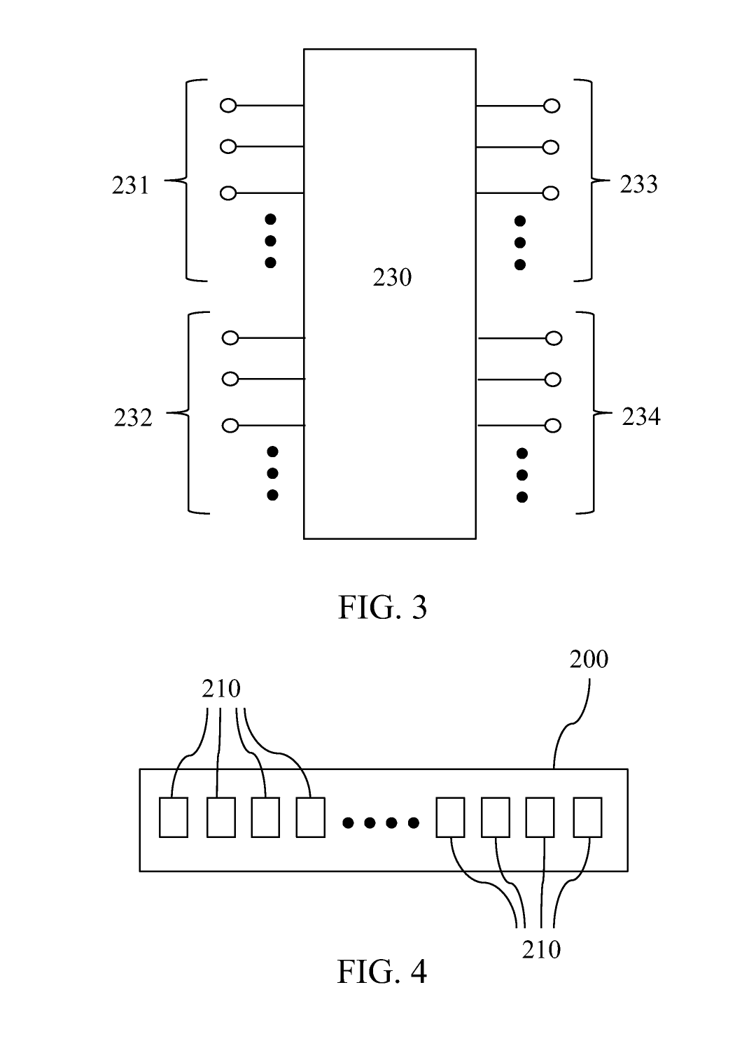

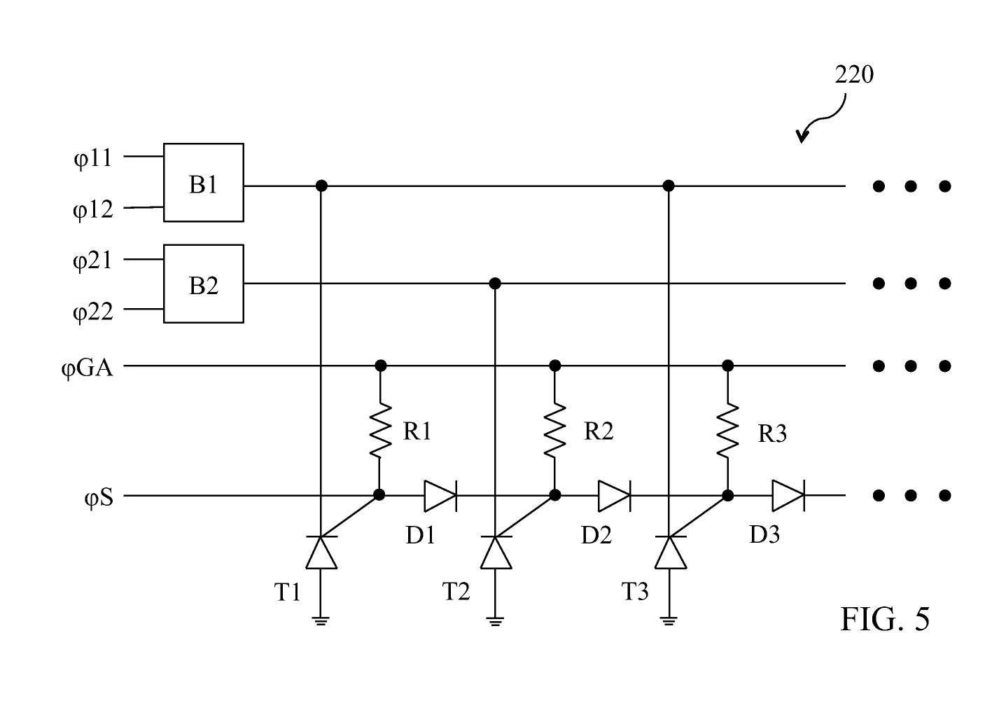

Referring to FIG. 2, a light emitting apparatus according to an embodiment of the disclosure includes a plurality of light emitting chips 200 and a long substrate 240. The light emitting chips 200 are arranged on the long substrate 240 along a longitudinal axis X. Herein, the light emitting chips 200 are arranged in an alternating manner along two sides of the longitudinal axis. Herein, each light emitting chip 200 includes a plurality of light emitting units 210, which are also arranged along the longitudinal axis of the long substrate (as shown in FIG. 4). Herein, the light emitting units 210 are substantially light thyristors T1, T2, T3, and so on (which are referred to as light thyristors T in general) as shown in FIG. 5. The long substrate having the light emitting chips 200 is substantially a printing head, which is used for emitting light to a photo-conductive drum of a printer. The printing head is electrically connected to a drive circuit 230 shown in FIG. 3, and the drive circuit 230 substantially may be implemented in the form of an integrated circuit (for example, a control chip in the printer).

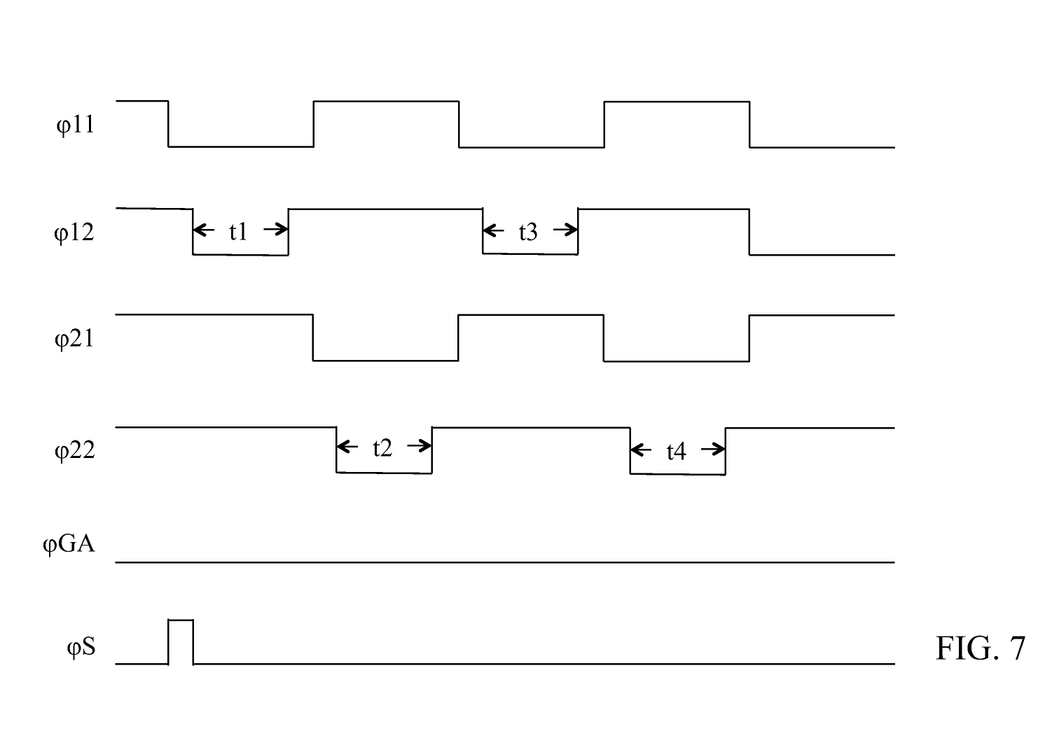

Referring to FIG. 2, FIG. 4, and FIG. 5 in combination, apart from the light emitting units 210, each light emitting chip 200 further includes a scanning circuit 220 (as shown in FIG. 5). The scanning circuit 220 receives a frequency signal combination, and scans the light emitting units 210 in sequence according to the frequency signal combination, so as to selectively enable the scanned light emitting units 210 to emit light. Herein, the frequency signal combination includes two scanning signals (φ11 and φ21), two light emitting signals (φ12 and φ22), a bias signal φGA, and a start signal φS (as shown in FIG. 7).

As shown in FIG. 2, the scanning circuit 220 has two scanning input ends (namely, a first scanning input end 221 and a second scanning input end 222), two control input ends (namely, a first control input end 223 and a second control input end 224), a start signal input end (not shown), and a bias input end (not shown).

As shown in FIG. 3, the drive circuit 230 has two scanning output ends (namely, a first scanning output end 231 and a second scanning output end 232), two control output ends (namely, a first control output end 233 and a second control output end 234), a start signal output end (not shown), and a bias output end (not shown).

Referring to FIG. 2, FIG. 3, and FIG. 5 in combination, the drive circuit 230 is electrically connected to the light emitting chips 200, and provides a frequency signal combination for each light emitting chip 200. In other words, the first scanning output end 231 is coupled to the first scanning input end 221, so as to provide a scanning signal φ11 to the light emitting chip 200; the second scanning output end 232 is coupled to the second scanning input end 222, so as to provide a scanning signal φ21 to the light emitting chip 200; the first control output end 233 is coupled to the first control input end 223, so as to provide a scanning signal φ12 to the light emitting chip 200; the second control output end 234 is coupled to the second control input end 224, so as to provide a scanning signal φ22 to the light emitting chip 200; the start signal output end is coupled to the start signal input end, so as to provide a start signal φS to the light emitting chip 200; and the bias output end is coupled to the bias input end, so as to provide a bias signal φGA to the light emitting chip 200.

Referring to FIG. 5, the scanning circuit 220 includes diodes (D1, D2, D3, and so on, which are referred to as diodes D in general), resistors (R1, R2, R3, and so on, which are referred to as resistors R in general), and buffers (B1 and B2). A gate of each light thyristor T is coupled to another light thyristor T through a corresponding diode D (for example, a light thyristor T1 is coupled to a light thyristor T2 through the diode D1). A cathode of each light thyristor T is correspondingly coupled to the first scanning input end 221 and first control input end 223 or to the second scanning input end 222 and second control input end 224 through the buffer (B1 or B2) in an alternating manner. For example, the cathode of the light thyristor T1 is coupled to an output end of the buffer B1, and the cathode of the light thyristor T2 is coupled to an output end of the buffer B2. A coupling point between the gate of each light thyristor T and the corresponding diode D is further coupled to the bias input end through a corresponding resistor, so as to receive a bias signal φGA (for example, a coupling point between the gate of the light thyristor T1 and the diode D1 is coupled to the bias input end through the resistor R1).

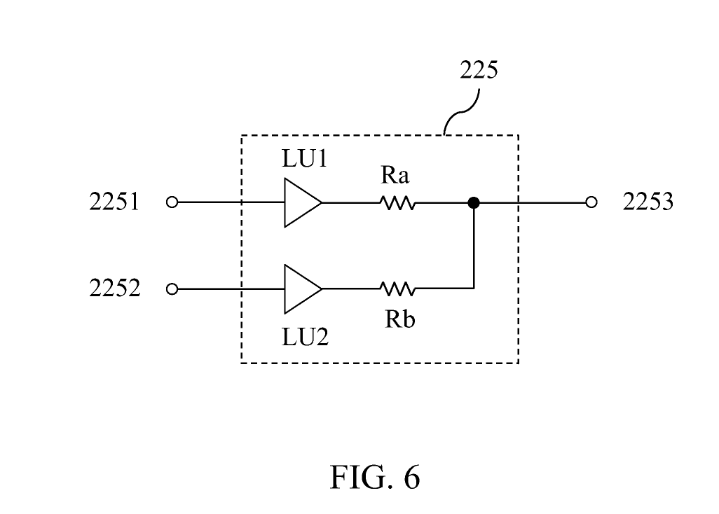

Referring to FIG. 6, the buffers B1 and B2 have a first buffer input end 2251, a second buffer input end 2252, and a buffer output end 2253. The buffers B1 and B2 each include two resistors (Ra and Rb) and two logic units (LU1 and LU2). The logic unit LU1 and the resistor Ra are connected in series between the first buffer input end 2251 and the buffer output end 2253. The logic unit LU2 and the resistor Rb are connected in series between the second buffer input end 2252 and the buffer output end 2253. Herein, the logic units (LU1 and LU2) are substantially buffers, but the embodiment of the disclosure is not limited thereto; the logic units may also be other logic gates such as Not Gate, or a combination thereof, which may be adjusted according to a relationship between a signal required by the scanning circuit 220 and a signal provided by the drive circuit 230.

The gate of the light thyristor T1 is coupled to the start signal φS. An anode end of the diode D is coupled to an adjacent light thyristor T near the start signal φS, and a cathode end of the diode D is coupled to another light thyristor T. For example, the anode end of the diode D1 is coupled to the light thyristor T1, and the cathode end thereof is coupled to the light thyristor T2.

The light thyristor T has a gate, a cathode, and an anode. When a forward bias exits between the gate and the cathode and the bias exceeds a diffusion voltage, the light thyristor T is lightened. The light thyristor is the same as common thyristors in that: after the light thyristor T is turned on (namely, lightened), gate potential is almost the same as anode potential, and the light thyristor T is not turned off (namely, the light thyristor T does not stop emitting light) until a potential difference between the gate and the cathode returns to 0 V.

As shown in FIG. 7, the scanning signals φ11 and φ21 are used for scanning the light thyristors T in sequence, so that the light thyristors T acquire the emitting light right in sequence. When a light thyristor T acquires the emitting light right and the corresponding control signal φ12 (or control signal φ22) has a lightening pulse, the corresponding light thyristor T emits light. For example, the control signal φ12 has a negative pulse during a period t1, and the light thyristor T1 emits light. Therefore, by means of the scanning circuit 220, the drive circuit 230 can control whether each light thyristor T emits light, and control a light emitting time point and a light emitting period thereof (for example, a period t2 is a light emitting period of the light thyristor T2; a period t3 is a light emitting period of the light thyristor T3; and a period t4 is a light emitting period of the light thyristor T4).

Herein, a high level of the scanning signals (φ11 and φ21), the control signals (φ12 and φ22), the bias signal φGA, and the start signal φS is 0 V, and a low level thereof is a negative working voltage (for example, −3.3 V), but the embodiment of the disclosure is not limited thereto; the high level and low level can be adjusted according to the architecture of the scanning circuit 220.

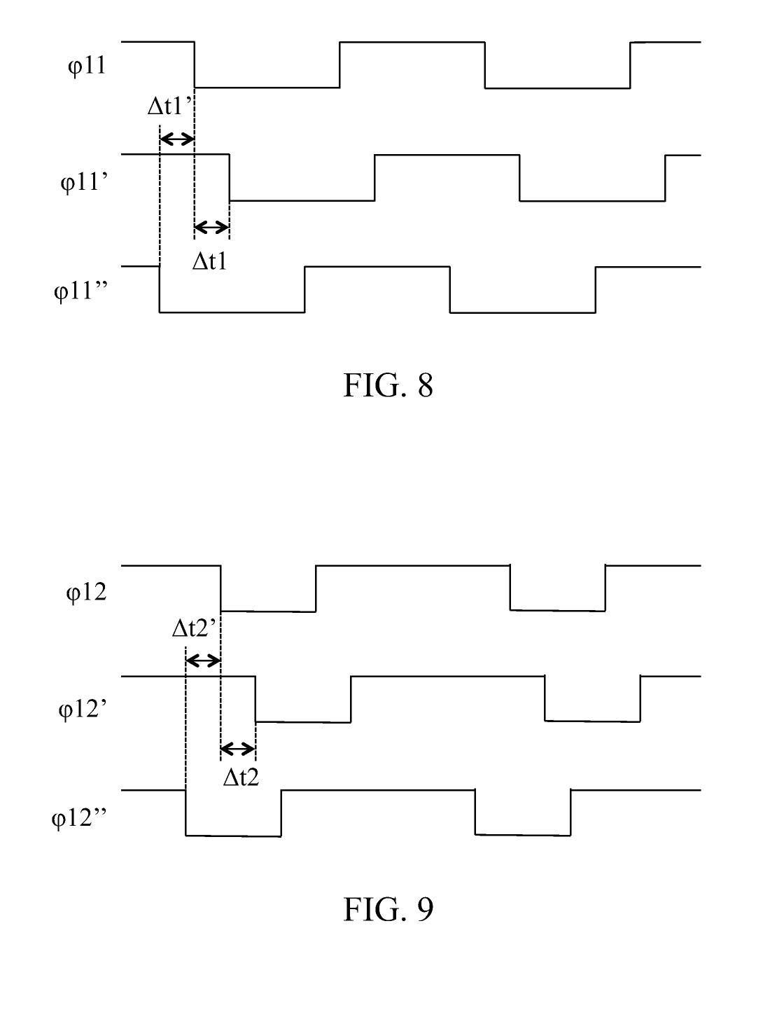

Referring to FIG. 8 and FIG. 9 in combination, the frequency signal combinations corresponding to the light emitting chips 200 are grouped into a plurality of groups (herein, the frequency signal combinations are grouped into three groups, and the scanning signal φ11 and the control signal φ12 are used as an example), and at least two of the groups have a delay therebetween, so that the light emitting units 210 (such as the light thyristors T1) corresponding to the same serial number emit light successively according to the delay. For example, shifting pulses (which are negative pulses herein) of a scanning signal φ11 and a scanning signal φ11′ of the light emitting units 210 corresponding to the same serial number have a delay Δt1 therebetween; shifting pulses (which are negative pulses herein) of the scanning signal φ11′ and a scanning signal φ11″ of the light emitting units 210 corresponding to the same serial number have a delay Δt1′ therebetween; lightening pulses (which are negative pulses herein) of a control signal φ12 and a control signal φ12′ of the light emitting units 210 corresponding to the same serial number have a delay Δt2 therebetween; and lightening pulses (which are negative pulses herein) of the control signal φ12′ and a control signal φ12″ of the light emitting units 210 corresponding to the same serial number have a delay Δt2′ therebetween. Herein, the delay refers to a time difference between two signals, and the signal sequence is not limited to the signal sequence shown in FIG. 8 or FIG. 9.

Herein, the period of the lightening pulse or the period of the shifting pulse is 2 to 200 times of the delay. When the delay is short, the frequency signal combinations corresponding to the light emitting chips 200 may be grouped into more groups. For example, the period of the lightening pulse or the period of the shifting pulse may be 1 microseconds (ms), and the delay may be 10 nanoseconds (ns).

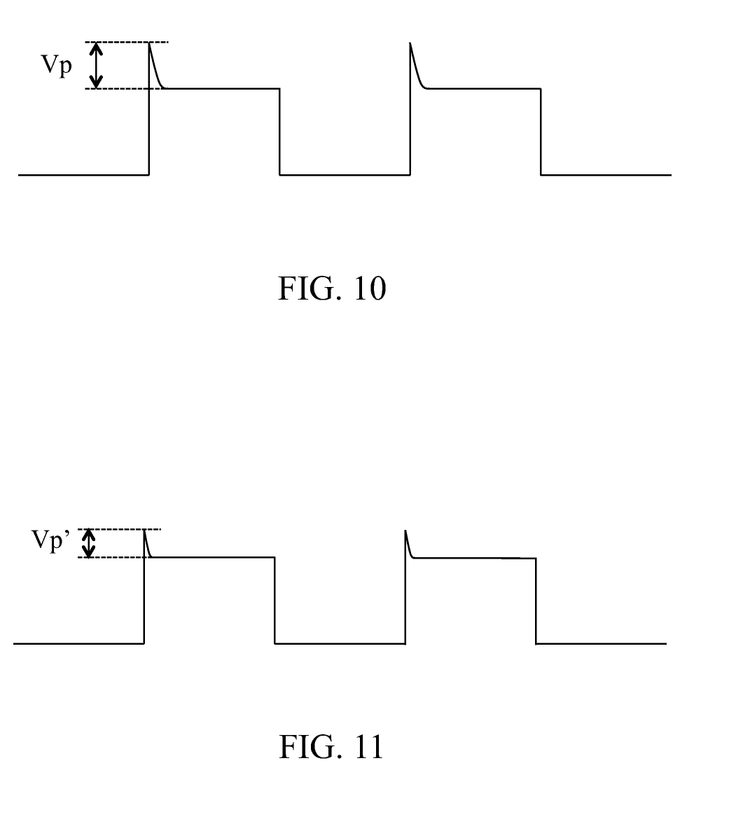

Referring to FIG. 10 and FIG. 11 in combination, FIG. 10 and FIG. 11 are respectively a schematic view of a scanning signal with a delay and a schematic view of a scanning signal without a delay. By means of grouping, scanning signals in the groups have a delay therebetween, so that a transient variation quantity of a working current is reduced, and a noise surge voltage is reduced from Vp to Vp′. If a delay exists between every two groups, Vp/Vp′ is approximately less than ½ of the number of groups. Herein, although FIG. 10 and FIG. 11 show the waveform of the scanning signal, this manner can be directly applied to the control manner.

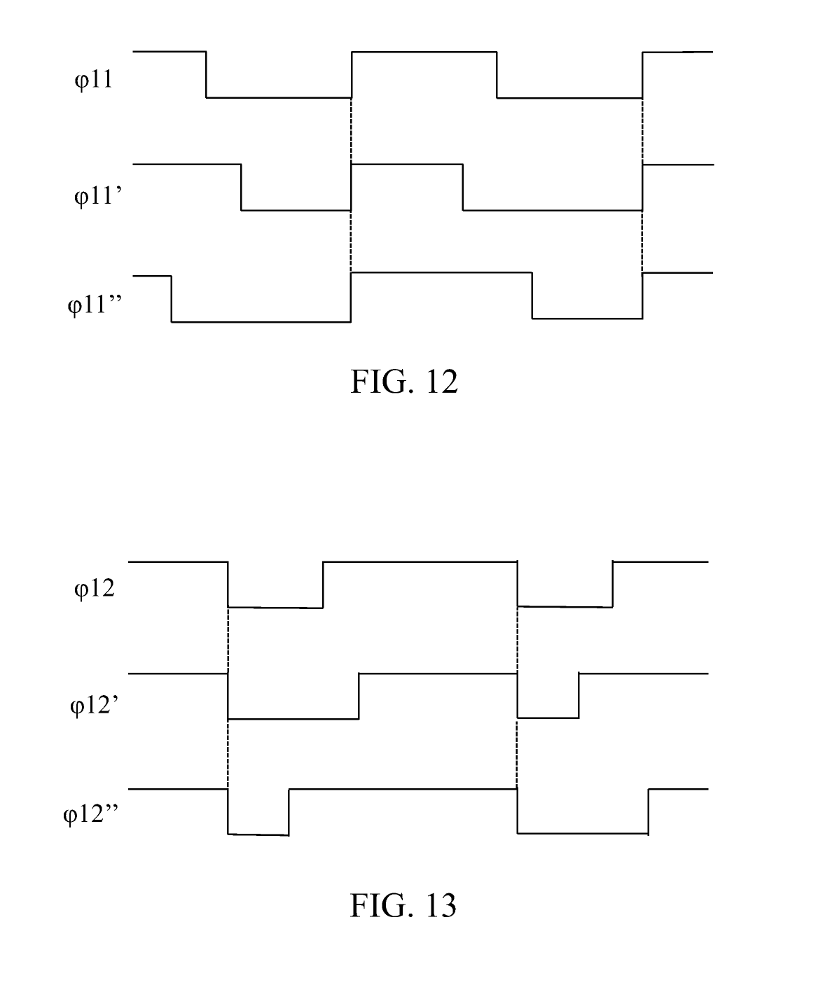

Referring to FIG. 12, FIG. 12 shows scanning signals of different light emitting chips 200, and rising edges (which are right edges herein) of shifting pulses of the scanning signals are aligned with each other. However, the embodiment of the disclosure is not limited thereto, and it is also possible that falling edges (left edges) of the shifting pulses of the scanning signals are aligned with each other.

Similarly, as shown in FIG. 13, falling edges (which are left edges herein) of lightening pulses of light emitting signals of different light emitting chips 200 are aligned with each other. However, the embodiment of the disclosure is not limited thereto, and it is also possible that rising edges (right edges) of the lightening pulses of the light emitting signals are aligned with each other.

Herein, the delay corresponds to a light emitting correcting value of the light emitting units 210 with the same serial number. In other words, when light emitted by the light emitting unit 210 is weak, a long lightening period is required, and the delay may be reduced to increase the period of the lightening pulse. On the contrary, when light emitted by the light emitting unit 210 is intense, the delay time may be prolonged to reduce the period of the lightening pulse.

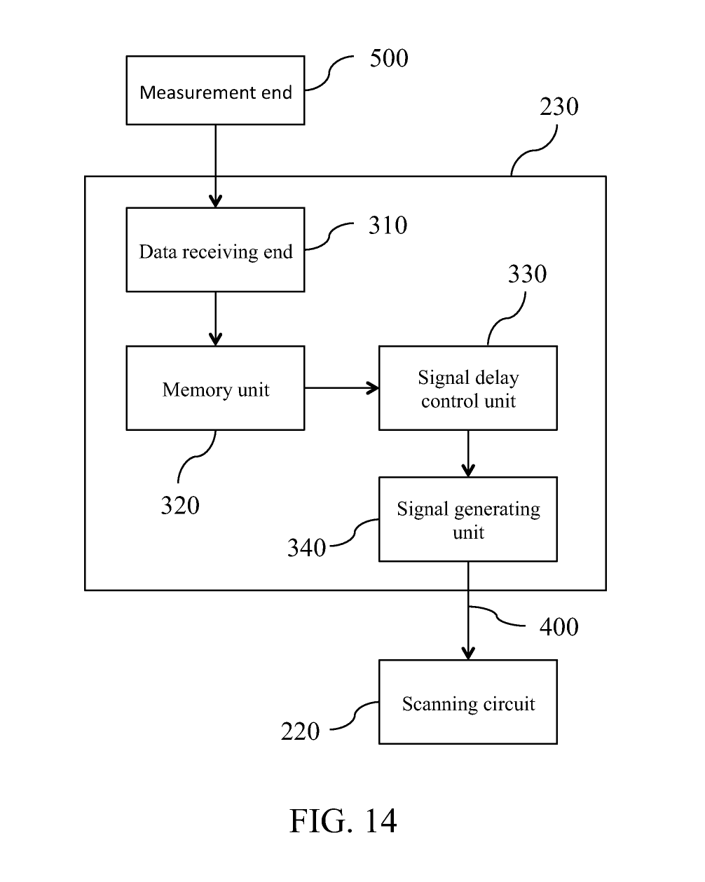

Referring to FIG. 14, the drive circuit 230 may include a data receiving end 310, a memory unit 320, a signal delay control unit 330, and a signal generating unit 340. To determine whether luminance of light emitted by each light emitting unit 210 meets expected luminance, the signal generating unit 340 may generate a frequency signal combination 400 as shown in FIG. 7. A measurement end 500 has a luminance detection unit (not shown), and therefore can detect the luminance of light emitted by each light emitting unit 210, thereby generating a piece of actual luminance information. As shown in FIG. 14, the measurement end 500 sends the actual luminance information to the data receiving end 310, so that the data receiving end 310 stores the actual luminance information in the memory unit 320.

In some embodiments, the measurement end 500 may generate the light emitting correcting value according to expected luminance and the actual luminance information, so that the light emitting correcting value of each light emitting unit 210 can be stored in the memory unit 320.

After the memory unit 320 stores the light emitting correcting value or actual luminance information, the signal delay control unit 330 may acquire light measurement data (such as the light emitting correcting value or actual luminance information) from the memory unit 320, so as to generate a delay signal. The signal generating unit 340 then generates a frequency signal combination 400 (as shown in FIG. 8, FIG. 9, FIG. 12, and FIG. 13) according to the delay signal. Herein, the delay signal may be a signal having a specific pulse quantity, where the specific pulse quantity may correspond to a delay required by a signal (such as the light emitting signal φ12). For example, when a longer delay is required, the specific pulse quantity may be increased. The signal generating unit counts the specific pulse quantity, and therefore can delay (or put ahead) the signal corresponding to the light emitting unit 210 by a period of time corresponding to the light emitting correcting value.

In an embodiment, the start signal φS in the frequency signal combination may be omitted by connecting the diode or resistor between the gate end of the light thyristor T1 and the buffer output end of the first buffer (or the second buffer).

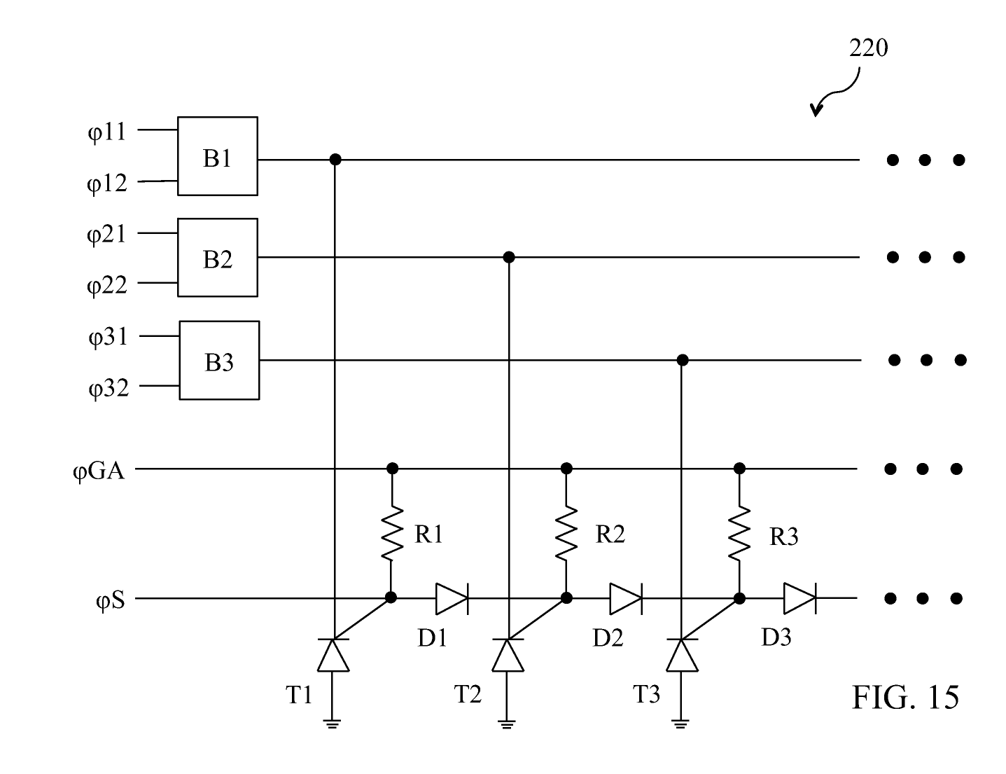

In an embodiment, a scanning signal φ31 and a light emitting signal φ32 may be added in the frequency signal combination (as shown in FIG. 15).

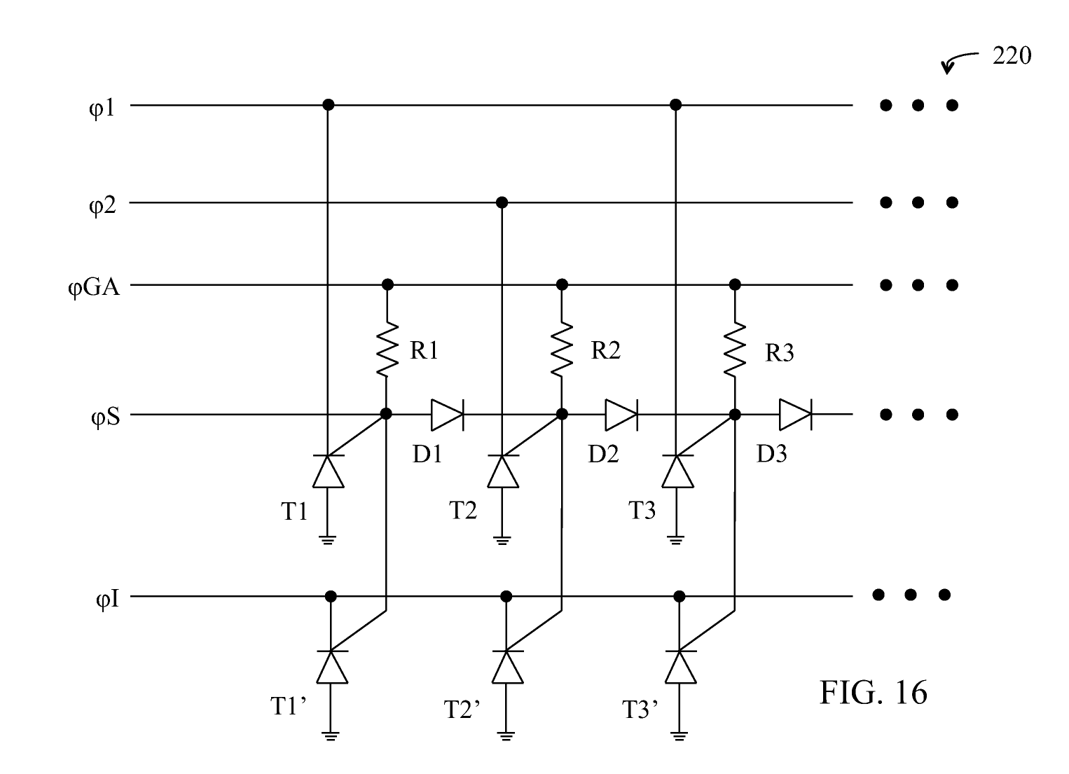

Referring to FIG. 16, compared with the scanning circuit 220 shown in FIG. 5, a scanning circuit 220 according to an embodiment further includes a plurality of light thyristors (T1′, T2′, T3′, and so on, which are referred to as light thyristors T′ in general). Gates of the light thyristors T′ are correspondingly connected to the gates of the light thyristors T, and anodes of the light thyristors T are also connected to the light thyristors T′. Cathodes of the light thyristors T′ receive luminance signals φ1, so that luminance of light emitted by the light thyristors T′ is adjusted according to the luminance signals φI.

Herein, the light thyristors T′ are the light emitting units 210 of the light emitting chips 200. The light thyristors T are a part of the scanning circuit 220, and the light thyristors T′ are made to be light emitting targets in sequence according to the scanning signals φ1 and φ2. Then, according to the luminance signal φI, a light thyristor T′ that becomes the light emitting target emits light. For the method for scanning the light thyristors T′ in sequence by using the scanning signals φ1 and φ2, please refer to related description of FIG. 5 and FIG. 7, and description is not repeated herein. In this embodiment, the frequency signal combination 400 includes two scanning signals (φ1 and φ2), a bias signal φGA, a start signal φS, and a luminance signal φI.

The light emitting apparatus capable of suppressing noise according to the disclosure can prevent too many light emitting chips 200 from driving light emitting units to emit light at the same time, thereby avoiding disturbing a working voltage of a printing head and avoiding malfunction of the printing head. Moreover, by arranging a delay between different light emitting chips 200, the problem of inconsistent luminance the light emitting units 210 can be solved.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A light emitting apparatus capable of suppressing noise, comprising:
a plurality of light emitting chips, each of the light emitting chips comprising:
a plurality of light emitting units; and
a scanning circuit, electrically connected to the light emitting units, receiving a frequency signal combination, and scanning the light emitting units in sequence, so as to selectively enable the scanned light emitting units to emit light; and
a drive circuit, electrically connected to the light emitting chips, so as to provide the frequency signal combination for each of the light emitting chips, wherein the frequency signal combinations are grouped into a plurality of groups, and at least two of the groups have a delay therebetween, so that the light emitting units corresponding to a same serial number emit light successively according to the delay.

2. The light emitting apparatus according to claim 1, wherein each of the frequency signal combinations comprises:
two light emitting signals, each of the light emitting signals having a lightening pulse corresponding to the light emitting units having the same serial number;
two scanning signals, each of the scanning signals having a shifting pulse corresponding to the light emitting units having the same serial number;
a start signal, for starting scanning the light emitting units; and
a bias signal, for maintaining operation of the scanning circuit,
wherein the lightening pulses of at least two of the groups or the shifting pulses of at least two of the groups have the delay therebetween.

3. The light emitting apparatus according to claim 2, wherein rising edges of the lightening pulses of at least two of the groups are aligned with each other.

4. The light emitting apparatus according to claim 2, wherein falling edges of the lightening pulses of at least two of the groups are aligned with each other.

5. The light emitting apparatus according to claim 2, wherein rising edges of the shifting pulses of at least two of the groups are aligned with each other.

6. The light emitting apparatus according to claim 2, wherein falling edges of the shifting pulses of at least two of the groups are aligned with each other.

7. The light emitting apparatus according to claim 2, wherein a period of the lightening pulse or a period of the shifting pulse is 2 to 200 times of the delay.

8. The light emitting apparatus according to claim 1, wherein each of the frequency signal combinations comprises a light emitting signal, each of the light emitting signals has a lightening pulse corresponding to the light emitting units having the same serial number, and the lightening pulses of at least two of the groups have the delay therebetween.

9. The light emitting apparatus according to claim 8, wherein rising edges of the lightening pulses of at least two of the groups are aligned with each other.

10. The light emitting apparatus according to claim 8, wherein falling edges of the lightening pulses of at least two of the groups are aligned with each other.

11. The light emitting apparatus according to claim 1, wherein the frequency signal combination comprises a scanning signal, each of the scanning signals has a shifting pulse corresponding to the light emitting units having the same serial number, and the shifting pulses of at least two of the groups have the delay therebetween.

12. The light emitting apparatus according to claim 11, wherein rising edges of the shifting pulses of at least two of the groups are aligned with each other.

13. The light emitting apparatus according to claim 11, wherein falling edges of the shifting pulses of at least two of the groups are aligned with each other.

14. The light emitting apparatus according to claim 1, wherein the delay corresponds to a light emitting correcting value of the light emitting units having the same serial number.

15. The light emitting apparatus according to claim 1, wherein the drive circuit comprises:
a data receiving end, for receiving external light measurement data;
a memory unit, coupled to the data receiving end, for storing the light measurement data;
a signal delay control unit, coupled to the memory unit, for acquiring the light measurement data; and
a signal generating unit, coupled to the signal delay control unit, for generating the frequency signal combination having the delay according to the light measurement data.
